(19) United States
(12) Patent Application Publication
(10) Pub. No.: US 2022/0225690 A1
(43) Pub. Date: Jul. 21, 2022

(54) Infant Bib Assembly

(71) Applicant: Kelly Kirby, Indianapolis, IN (US)

(72) Inventor: Kelly Kirby, Indianapolis, IN (US)

(21) Appl. No.: 17/153,954

(22) Filed: Jan. 21, 2021

(51) Int. Cl. A41B 13/10; A61J 17/00

(52) U.S. Cl. CPC A41B 13/10; A61J 17/111; A61J 17/001

(57) ABSTRACT

An infant bib assembly for inhibiting an infant from dropping a pacifier includes a bib that has a collar being integrated therein to extend around the infants' neck when the bib is worn for retaining the bib on the infant. A wire is integrated into the bib thereby facilitating the collar to be shaped. In this way the wire facilitates the collar to be shaped around the infant's neck to inhibit the bib from falling off of the infant. A pacifier is removably attachable to the bib to inhibit the pacifier from being dropped when the bib is being worn and the infant is suckling on the pacifier. In this way a caregiver does not have to continually retrieve the pacifier when the infant drops the pacifier.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bib devices and more particularly pertains to a new bib device for inhibiting an infant from dropping a pacifier. The bib device includes a wire extending around a collar of the bib thereby facilitating the collar to be shaped around the infant's neck. In this way the pacifier can be positioned near the infant's mouth when the bib is worn.

### (2) Description of Related Art Including Information Disclosed Under 37 CFR 1.97 and 1.98

The prior art relates to bib devices including a variety of bibs that have a flap integrated therein for engaging a ring of a pacifier. The prior art discloses a bib that has a pacifier mounted adjacent to a collar of the bib for positioning the pacifier near the infant's mouth when the bib is worn. The prior art also discloses a variety of bibs that have a strap coupled thereto when can releasably engage a pacifier. In no instance does the prior art disclose a bib that has a wire shaped collar and a pacifier that is removably attachable to the bib.

### BRIEF SUMMARY OF THE INVENTION

An embodiment of the disclosure meets the needs presented above by generally comprising a bib that has a collar being integrated therein to extend around the infants' neck when the bib is worn for retaining the bib on the infant. A wire is integrated into the bib thereby facilitating the collar to be shaped. In this way the wire facilitates the collar to be shaped around the infant's neck to inhibit the bib from falling off of the infant. A pacifier is removably attachable to the bib to inhibit the pacifier from being dropped when the bib is being worn and the infant is suckling on the pacifier. In this way a caregiver does not have to continually retrieve the pacifier when the infant drops the pacifier.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of an infant bib assembly according to an embodiment of the disclosure.

FIG. 2 is a back perspective view of an embodiment of the disclosure.

FIG. 3 is a front phantom view of an embodiment of the disclosure.

FIG. 4 is a back exploded view of an embodiment of the disclosure.

FIG. 5 is a perspective in-use view of an embodiment of the disclosure.

FIG. 6 is a perspective view of an alternative embodiment of the disclosure.

FIG. 7 is a cross sectional view taken along line 7-7 of FIG. 3 of an embodiment of the disclosure.

### DETAILED DESCRIPTION OF THE INVENTION

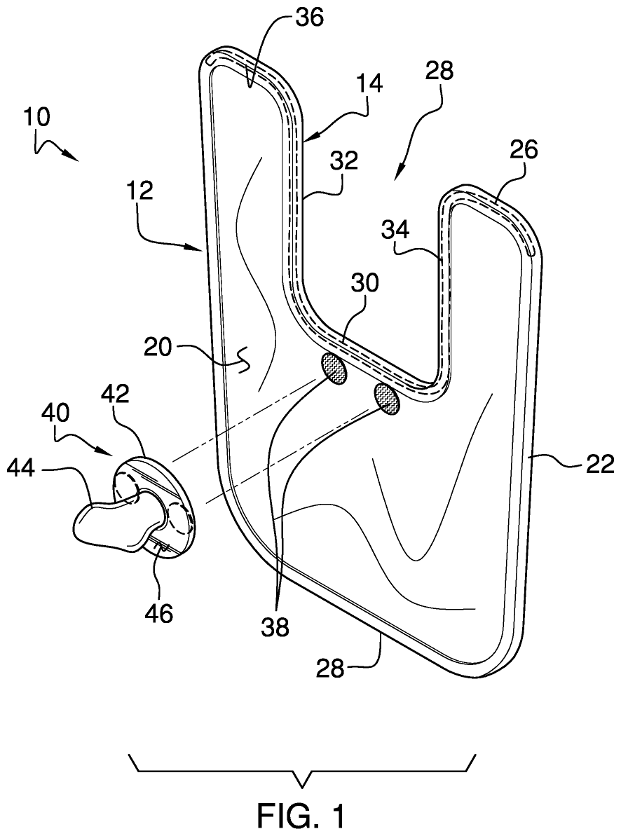

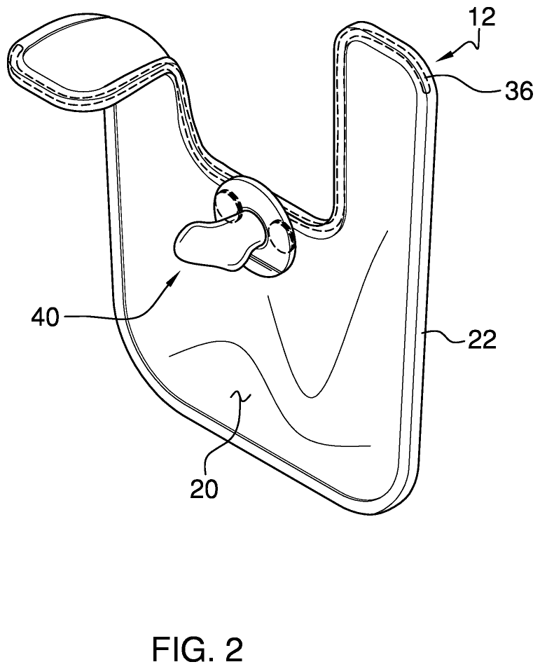

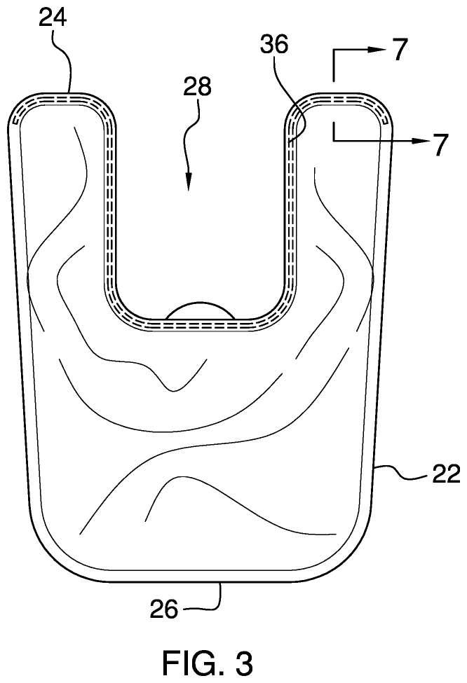

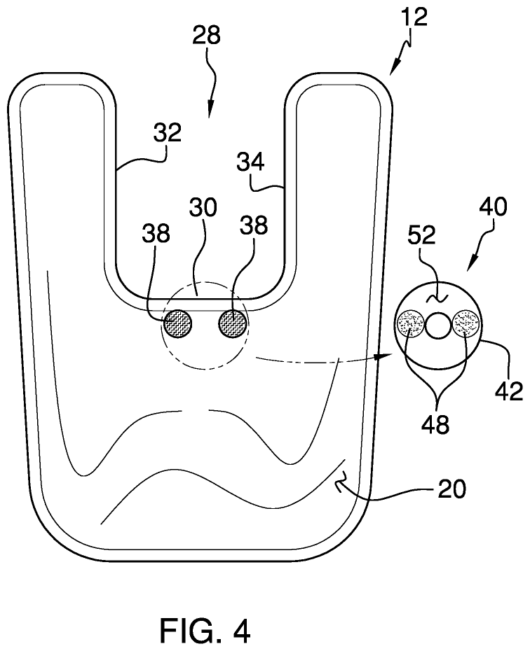

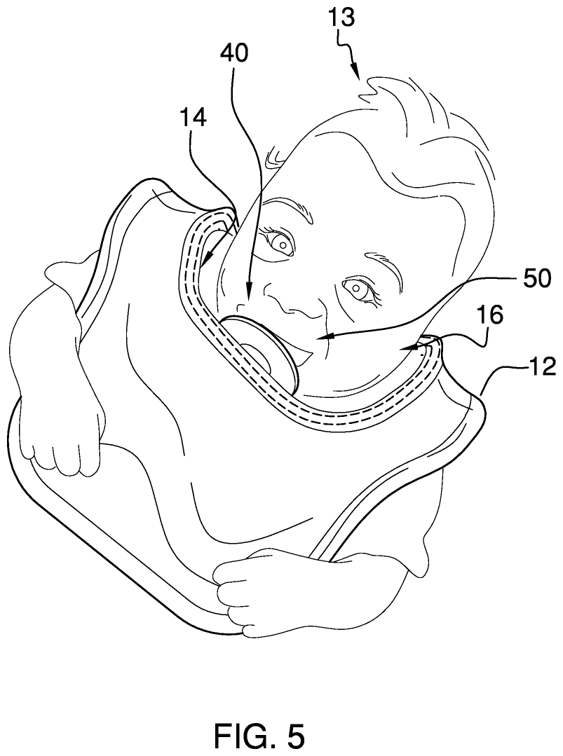

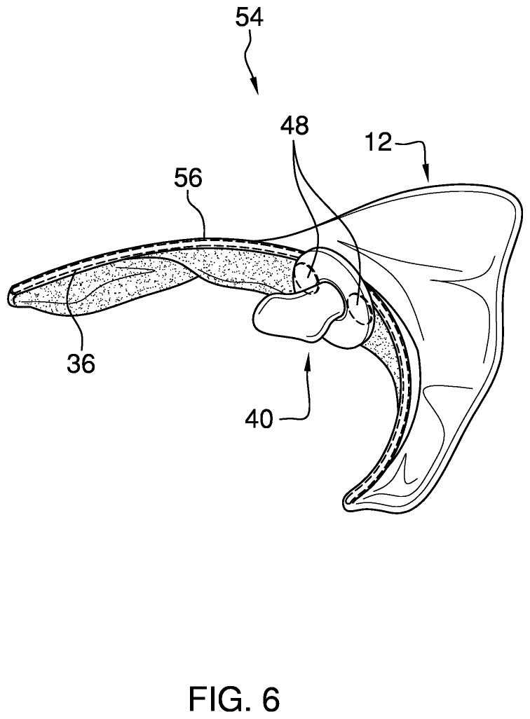

With reference now to the drawings, and in particular to FIGS. 1 through 7 thereof, a new bib device embodying the principles and concepts of an embodiment of the disclosure and generally designated by the reference numeral 10 will be described.

As best illustrated in FIGS. 1 through 7, the infant bib assembly 10 generally comprises a bib 12 that is comprised of a fluid impermeable material to protect an infant's clothing from liquid when the infant 13 wears the bib 12. The fluid impermeable material might be plastic, a woven synthetic material or other type of flexible material that is also fluid impermeable. A collar 14 is integrated into the bib 12 to extend around the infant's neck 16 when the bib 12 is worn thereby retaining the bib 12 on the infant 13. The bib 12 has a first surface 20 and a perimeter edge 22, and the perimeter edge 22 has a top side 24 and a bottom side 26. The top side 24 has a slot 28 extending toward the bottom side 26 such that the slot 28 defines the collar 14, and the slot 28 is centrally positioned on the top side 24. The slot 28 has a lower bounding edge 30, a first lateral bounding edge 32 and a second lateral bounding edge 34.

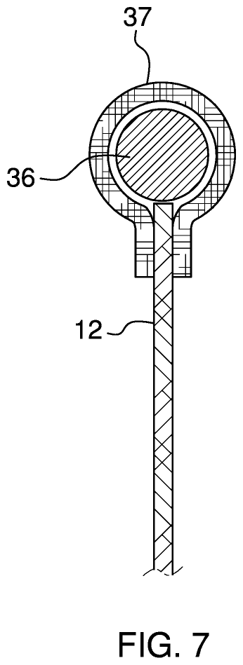

A wire 36 is integrated into the bib 12 and the wire 36 extends around the collar 14. The wire 36 is comprised of a bendable material thereby facilitating the collar 14 to be shaped. In this way the wire 36 facilitates the collar 14 to be shaped around the infant's neck 16 to inhibit the bib 12 from falling off of the infant 13. The wire 36 extends along each of the first lateral bounding edge 32, the second lateral bounding edge 34 and the lower bounding edge 30 of the slot 28 in the top side 24 of the bib 12. The wire 36 extends along the top side 24 on opposite sides of the slot 28. As is most clearly shown in FIG. 7, an enclosure 37 may be coupled to the bib 12 and the enclosure 37 may extend around the perimeter edge 22 of the bib 12. Additionally, the wire 36 may be positioned in the enclosure 37.

A pair of first mating members 38 is provided and each of the first mating members 38 is coupled to the bib 12. Each of the first mating members 38 is positioned adjacent to the collar 14 and each of the first mating members 38 is positioned on the first surface 20 of the bib 12. Each of the first mating members 38 is positioned adjacent to the lower bounding edge 30 of the slot 28 thereby facilitating each of the first mating members 38 to be positioned proximate the infant's face when the bib 12 is worn. Each of the first mating members 38 may comprise hook and loop fasteners or the like. Additionally, the first surface 20 of the bid and the first mating members 38 are directed toward the infant 13 when the bib 12 is worn.

A pacifier 40 is removably attachable to the bib 12 such that the pacifier 40 is inhibited from being dropped when the bib 12 is being worn and the infant 13 is suckling on the pacifier 40. The pacifier 40 includes a panel 42 and a nipple 44 extending away from a front surface 46 of the panel 42. Moreover, panel 42 and the nipple 44 may be constructed in a similar fashion to a variety of different manufacturers of pacifiers.

A pair of second mating members 48 is each of the second mating members 48 is coupled to the pacifier 40. Each of the second mating members 48 is releasably matable to a respective one of the first mating members 38 for retaining the pacifier 40 on the bib 12. In this way the pacifier 40 is aligned with the infant's mouth 50 when the bib 12 is worn. Each of the second mating members 48 is positioned on a back surface 52 of the panel 42 associated with the pacifier 40. Additionally, each of the second mating members 48 may comprise a hook and loop fasteners or the like.

In an alternative embodiment 54 as is most clearly shown in figure the slot 28 has a bounding edge 56, and the bounding edge 56 is concavely arcuate with the top side 24 of the perimeter edge 22 of the bib 12. Continuing in the alternative embodiment 54, the bib 12 is comprised of a loosely woven material thereby facilitating each of the second mating members 48 on the pacifier 40 to engage the bib 12 rather than the first mating members 38. The loosely woven material may include, but not be limited to, terry cloth or fleece.

In use, the collar 14 is placed around the infant's neck 16 and the wire 36 is shaped to retain the bib 12 on the infant 13. The pacifier 40 is coupled to the bib 12 thereby facilitating the infant 13 to suckle on the pacifier 40. Additionally, the first mating members 38 and the second mating members 48 inhibit the infant 13 from dropping the pacifier 40. In this way a caregiver does not have to continually retrieve the pacifier 40 for the infant 13.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An infant bib assembly having a pacifier being removably attached thereto wherein said infant bib is configured to inhibit said pacifier from being dropped when said infant bib is worn on an infant, said assembly comprising:
a bib being comprised of a fluid impermeable material wherein said bib is configured to protect an infant's clothing from liquid when the infant wears said bib, said bib having a collar being integrated therein wherein said collar is configured to extend around the infants' neck when said bib is worn for retaining said bib on the infant;
a wire being integrated into said bib, said wire extending around said collar, said wire being comprised of a bendable material thereby facilitating said collar to be shaped wherein said wire is configured to facilitate said collar to be shaped around the infant's neck to inhibit said bib from falling off of the infant;
a pair of first mating members, each of said first mating members being coupled to said bib, each of said first mating members being positioned adjacent to said collar;
a pacifier being removably attachable to said bib wherein said pacifier is configured to be inhibited from being dropped when said bib is being worn and the infant is suckling on said pacifier; and
a pair of second mating members, each of said second mating members being coupled to said pacifier, each of said second mating members being releasably matable to a respective one of said first mating members for retaining said pacifier on said bib wherein said pacifier is configured to be aligned with the infant's mouth when said bib is worn.

2. The assembly according to claim 1, wherein said bib has a first surface and a perimeter edge, said perimeter edge having a top side and a bottom side, said top side having a slot extending toward said bottom side such that said slot defines said collar, said slot being centrally positioned on said top side, said slot having a lower bounding edge, a first lateral bounding edge and a second lateral bounding edge.

3. The assembly according to claim 2, wherein said wire extends along each of said first lateral bounding edge, said second lateral bounding edge and said lower bounding edge of said slot in said top side of said bib, said wire extending along said top side on opposite sides of said slot.

4. The assembly according to claim 2, wherein each of said first mating members is positioned on said first surface of said bib, each of said first mating members being positioned adjacent to said lower bounding edge of said slot wherein each of said first mating members is configured to be positioned proximate the infant's face when said bib is worn.

5. The assembly according to claim 1, wherein:
said pacifier includes a panel and a nipple extending away from a front surface of said panel; and
each of said second mating members being positioned on a back surface of said panel associated with said pacifier.

6. An infant bib assembly having a pacifier being removably attached thereto wherein said infant bib is configured to inhibit said pacifier from being dropped when said infant bib is worn on an infant, said assembly comprising:
a bib being comprised of a fluid impermeable material wherein said bib is configured to protect an infant's clothing from liquid when the infant wears said bib, said bib having a collar being integrated therein wherein said collar is configured to extend around the infants' neck when said bib is worn for retaining said bib on the infant, said bib having a first surface and a perimeter edge, said perimeter edge having a top side and a bottom side, said top side having a slot extending toward said bottom side such that said slot defines said collar, said slot being centrally positioned on said top side, said slot having a lower bounding edge, a first lateral bounding edge and a second lateral bounding edge;
a wire being integrated into said bib, said wire extending around said collar, said wire being comprised of a bendable material thereby facilitating said collar to be shaped wherein said wire is configured to facilitate said collar to be shaped around the infant's neck to inhibit said bib from falling off of the infant, said wire extending along each of said first lateral bounding edge, said second lateral bounding edge and said lower bounding edge of said slot in said top side of said bib, said wire extending along said top side on opposite sides of said slot;
a pair of first mating members, each of said first mating members being coupled to said bib, each of said first mating members being positioned adjacent to said collar, each of said first mating members being positioned on said first surface of said bib, each of said first mating members being positioned adjacent to said lower bounding edge of said slot wherein each of said first mating members is configured to be positioned proximate the infant's face when said bib is worn;
a pacifier being removably attachable to said bib wherein said pacifier is configured to be inhibited from being dropped when said bib is being worn and the infant is suckling on said pacifier, said pacifier including a panel and a nipple extending away from a front surface of said panel; and
a pair of second mating members, each of said second mating members being coupled to said pacifier, each of said second mating members being releasably matable to a respective one of said first mating members for retaining said pacifier on said bib wherein said pacifier is configured to be aligned with the infant's mouth when said bib is worn, each of said second mating members being positioned on a back surface of said panel associated with said pacifier.

7. The assembly according to claim 6, wherein said slot has a bounding edge, said bounding edge being concavely arcuate with said top side of said perimeter edge of said bib.

8. The assembly according to claim 6, wherein said bib is comprised of a loosely woven material thereby facilitating each of said second mating members on said pacifier to engage said bib rather than said first mating members.
